(19) United States
(12) Patent Application Publication
(10) Pub. No.: US 2026/0295873 A1
(43) Pub. Date: Oct. 1, 2026

(54) ACTUATOR AND ROBOT

(71) Applicant: FANUC CORPORATION, Yamanashi (JP)

(72) Inventor: Kazutaka Nakayama, Yamanashi (JP)

(21) Appl. No.: 19/480,184

(22) PCT Filed: May 19, 2023
(86) PCT No.: PCT/JP2023/018725

§ 371 Date: Oct. 30, 2025

(51) Int. Cl. B25J 19/00

(52) U.S. Cl. CPC B25J 19/0029

(57) ABSTRACT

An actuator including a fixing member, a movable member, and a hollow hole, wherein a wire body passes through the hollow hole. The wire body includes at least a pair of first wire bodies having a first diameter and a pair of second wire bodies having a second diameter smaller than the first diameter. Each of the pair of first wire bodies is a single wire or a twisted pair wire. The pair of second wire bodies are twisted pair wires.

### CROSS-REFERENCE TO RELATED APPLICATIONS

This application is a National Stage application of International Application No. PCT/JP2023/018725 filed May 19, 2023.

### BACKGROUND

### Field

The present disclosure relates to an actuator and a robot.

### Discussion of the Related Art

Industrial robots, and in particular, articulated robots, comprise at least one joint where two links are connected to each other. An actuator for driving the links is provided in such a joint, and at least a power line for driving the actuator is needed. Furthermore, signal lines, air tubes, coaxial cables, high-speed communication signal lines, etc., are required for driving an end effector or a sensor provided at the tip of the industrial robot. In the present description, these power lines, air tubes, coaxial cables, and various signal lines are sometimes collectively referred to as “filamentary bodies.”

In Japanese Unexamined Patent Publication No. 2017-159397, an actuator comprises a fixed member and a movable member which rotate relative to each other. The filamentary body penetrates the interior of the actuator, and is affixed to the fixed member and the movable member by a first affixation part and a second affixation part, respectively.

Filamentary bodies may comprise twisted pairs of wires, in which pairs of conductor wires covered with insulating parts are twisted together in order to make the filamentary body less susceptible to noise. If the diameters of conductor wires constituting a twisted pair of wires, such as power lines, are large, the insulating parts around the conductor wires may expand and contract greatly when the robot is driven, causing the insulating parts to break sooner than expected. Furthermore, in locations where the insulating part breaks, stresses acting on the filamentary body act directly on the conductor wire, and as a result, it is only a matter of time before the conductor wire breaks.

Thus, an actuator which can extend the life of the filamentary body is desired.

### SUMMARY

According to a first aspect of the present disclosure, there is provided an actuator, comprising a fixed member, a movable member which rotates relative to the fixed member, a hollow hole which penetrates the actuator, a filamentary body which passes through an interior of the hollow hole, a first affixation part for affixing one portion of the filamentary body, and a second affixation part for affixing another portion of the filamentary body, wherein the filamentary body includes at least a pair of first filamentary bodies having a first diameter and a pair of second filamentary bodies having a second diameter which is smaller than the first diameter, each of the pair of first filamentary bodies is a single wire, and the pair of second filamentary bodies is a twisted pair of wires.

The objects, features, and advantages of the present disclosure will be further clarified by the following description of embodiments in association with the attached drawings.

### BRIEF DESCRIPTION OF DRAWINGS

FIG. 1 is a perspective view of a robot comprising an actuator based on a first embodiment.

FIG. 2 is an axial cross-sectional view of the actuator based on the first embodiment.

FIG. 3 is an enlarged view of a portion of a filamentary body of the first embodiment.

FIG. 4 is an enlarged view of a portion of a filamentary body of a second embodiment.

FIG. 5A is an axial cross-sectional view of an actuator of a first modification example.

FIG. 5B is an axial cross-sectional view of an actuator of a second modification example.

FIG. 6A is a radial cross-sectional view of a filamentary body of an example.

FIG. 6B is a radial cross-sectional view of a filamentary body of another example.

### DESCRIPTION OF EMBODIMENTS

The embodiments of the present disclosure will be described below with reference to the attached drawings. In the drawings, corresponding constituent elements have been assigned common reference signs.

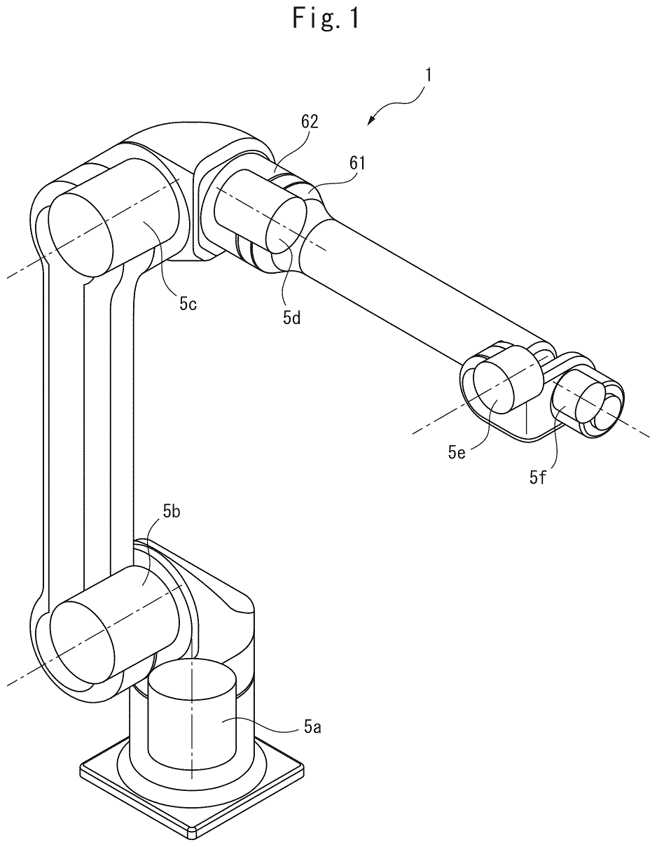

FIG. 1 is a perspective view of a robot comprising an actuator based on a first embodiment. A plurality of joints of a robot 1, for example, a vertical articulated robot, comprises respective actuators 5a to 5f. The actuators 5a to 5f may be incorporated in a machine different from the robot 1, for example, a machine tool. Though an actuator 5 will be described below, the actuators 5a to 5f shown in FIG. 1 can also be assumed to have similar configurations.

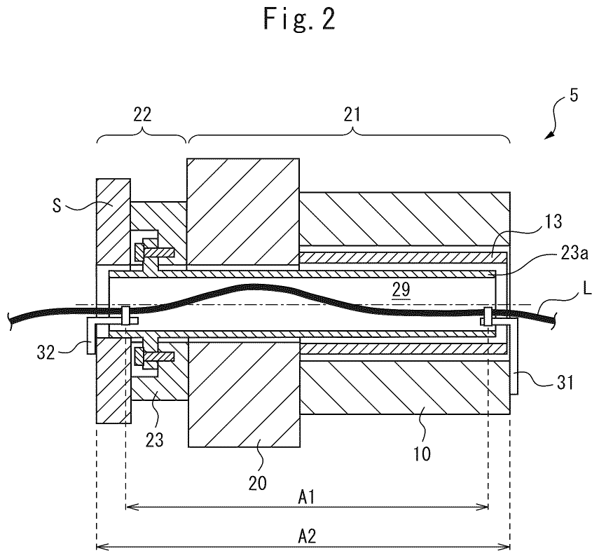

FIG. 2 is an axial cross-sectional view of the actuator based on the first embodiment. The actuator 5 is primarily composed of a fixed member 21 and a movable member 22 which rotates relatively to the fixed member 21. Specifically, the fixed member 21 comprises a motor 10, for example, a servo motor, which is composed of a stator and a rotor, and a speed reducer 20 which is connected to a motor shaft 13 of the motor 10. The movable member 22 comprises an output shaft 23 of the speed reducer 20 and a force sensor S which is coupled to the output shaft 23. As will be described later, the movable member 22 may be configured so as to comprise only the output shaft 23 of the speed reducer 20.

In the present disclosure, it is defined that the speed reducer 20 is arranged in front of the motor 10, and the motor 10 is arranged behind of the speed reducer 20. In principle, the “radial direction” in the present disclosure means the radial direction of the actuator 5, etc., and the “axial direction” means the axial direction of the actuator 5, etc.

The motor shaft 13 of the motor 10 is connected to the speed reducer 20. The tip of the output shaft 23 of the speed reducer 20 is connected to a link 2 (not illustrated) via the force sensor S. Thus, the actuator 5 controls the positioning of the link 2 (not illustrated) by rotating it relatively to the actuator 5 within a predetermined operating range. The reduction ratio of the speed reducer 20 is, for example, 1:50.

The motor shaft 13 is, for example, a hollow shaft. An extension part 23a, for example, a pipe member, is connected to the output shaft 23 of the speed reducer 20, and this extension part 23a extends through the hollow motor shaft 13 toward the motor 10. The extension part 23a is a protective member for the filamentary body L provided to prevent the filamentary body L from directly contacting the motor shaft 13, which rotates at high speed. The output shaft 23 of the speed reducer 20 and the extension part 23a may be integrally formed. In other words, the extension part 23a may be one portion of the output shaft 23. Thus, the “extension part 23a” may hereinafter be expressed as the “output part 23.”

The force sensor S is composed of a torque sensor for detecting the force acting around the axis of the actuator 5. As is well known, the force sensor S has a strain detection unit that connects two sensor components arranged concentrically. When a force acts around the axis of the actuator 5, the rigid strain detection unit elastically deforms in a direction that slightly extends, such that the force acting around the axis can be detected via the deformation amount of the strain detection unit. The force sensor S may be a strain gauge, a capacitance sensor, a magnetic sensor, an optical encoder sensor, or the like.

As shown in the drawing, the force sensor S, the speed reducer 20, and the motor 10, which are connected to each other coaxially, have common hollow holes 29. It is preferable that the hollow holes 29 of the force sensor S, the speed reducer 20, and the motor 10 have substantially the same inner diameter. As a result, the extension part 23a, for example, a pipe member, can be smoothly arranged. In other words, the actuator 5 has a hollow hole 29 formed in the axial direction, which penetrates the entire actuator 5. The hollow hole 29 shown in FIG. 2 is formed by the inner peripheral surface of the motor 10, the inner peripheral surface of the speed reducer 20, and the inner peripheral surface of the force sensor S. Thus, the hollow hole 29 includes the extension part 23a and the motor shaft 13 located outside the extension part 23a. As shown in the drawing, the extension part 23a extends over substantially the entire length of the actuator 5. It is preferable that the extension part 23a be shorter than the entire length of the actuator 5. At least one filamentary body L, such as a power line, a signal line, an air tube, a coaxial cable, or a signal line for high-speed communication, passes through the interior of the extension part 23a. The filamentary body L is a movable filamentary body that is resistant to twisting and bending motions, and refers to a state in which the various types of wires mentioned above are laid in parallel in a bundle.

As shown in FIG. 2, one portion of the filamentary body L is affixed to the fixed member 21 by a first affixation part 31. The other portion of the filamentary body L is affixed to the movable member 22 by a second affixation part 32.

In FIG. 2, the first affixation part 31 is affixed to the rear end surface of the motor 10, and the second affixation part 32 is affixed to a portion on the front end surface close to the inner periphery of the sensor S that does not affect the detection of the sensor S. However, for example, when the actuator 5 is an actuator 5d mounted on the robot 1, the first affixation part 31 may be affixed to an arm member 62 on the arm affixation (non-rotating) side, and the second affixation part 32 may be affixed to another arm member 61 on the rotating side of the arm adjacent to the arm member 62. It is assumed below that the first affixation part 31 is affixed to the rear end surface of the fixed member 21, the fixed member 21 is connected to the arm member 61, the second affixation part 32 is affixed to the front end surface of the movable member 22, and the movable member 22 is connected to the arm member 61. Regarding the orientation of the actuator to be attached, the force sensor S may be connected to the arm member 62 on the fixed (non-rotating) side of the arm, and the fixed member 21 may be connected to the arm member 61 on the rotating side of the arm.

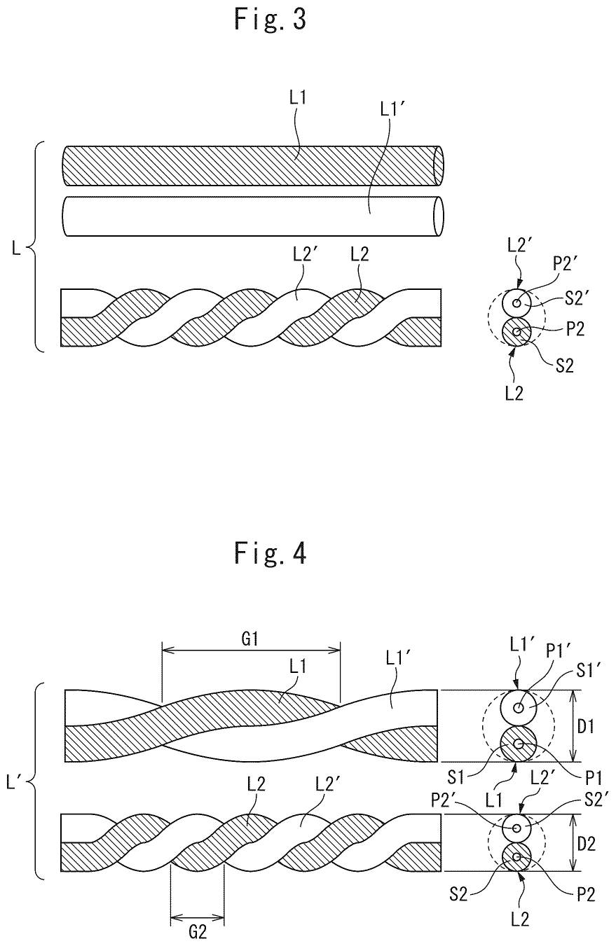

FIG. 3 is an enlarged view of a portion of the filamentary body of the first embodiment. In FIG. 3, the filamentary body L comprises a pair of first filamentary bodies L1, L1′ and a pair of second filamentary bodies L2, L2′. On the right side of FIG. 3, a radial cross section of the pair of second filamentary bodies L2, L2′ is shown. The second filamentary bodies L2, L2′ are electric wires including conductor wires P2, P2′ and insulating parts S2, S2′ surrounding the conductor wires P2, P2′, respectively. Note that on the right side of FIG. 4, which is described later, the first filamentary bodies L1, L1′ comprise conductor wires P1, P1′ and insulating parts S1, S1′ surrounding the conductor wires P1, P1′, respectively.

The pair of first filamentary bodies L1, L1′ have first cross-sectional areas m1 that are equal to each other, and the pair of second filamentary bodies L2, L2′ also have second cross-sectional areas m2 that are equal to each other. The conductor cross-sectional areas of the conductor wires of the pair of first filamentary bodies L1, L1′ are equal to each other, and the conductor cross-sectional areas of the conductor wires of the pair of second filamentary bodies L2, L2′ are equal to each other. The first cross-sectional area m1 of the pair of first filamentary bodies L1, L1′ is larger than the second cross-sectional area m2 of the pair of second filamentary bodies L2, L2′. Furthermore, the conductor cross-sectional area of the conductor wires of the pair of first filamentary bodies L1, L1′ is larger than the conductor cross-sectional area of the conductor wires of the pair of second filamentary bodies L2, L2′. In one example, the conductor cross-sectional area of the pair of first filamentary bodies L1, L1′ is 1.25 square millimeters, and the conductor cross-sectional area of the conductor wire of the pair of second filamentary bodies L2, L2′ is 0.2 square millimeters. It should also be noted that, in general, in electric wires, the outermost diameter of the insulating part and the outer diameter of the conductor wire are proportional to each other.

The pair of first filamentary bodies L1, L1′ may be power lines for supplying current to the fixed member 21 of the actuator 5, for example, the motor 10, or power lines for driving a tool attached to the wrist of the robot. The pair of second filamentary bodies L2, L2′ may be signal lines for transmitting and receiving control signals to the actuator 5 and signals from the sensor S and the encoder E.

In general, when twisted pairs of wires are twisted in a direction in which the twist loosens, the stresses acting on the insulating part is small, but when twisted in a direction in which the twist tightens, the stresses acting on the insulating part tends to increase.

In contrast to the foregoing, as shown in FIG. 3, the pair of first filamentary bodies L1, L1′ are independent single wires that extend approximately parallel to each other and are not twisted, and the pair of second filamentary bodies L2, L2′ are a twisted pair of wires. Thus, even when the movable member 22 of the actuator 5 rotates relative to the fixed member 21, since the pair of first filamentary bodies L1, L1′ are not entangled with each other, the pair of first filamentary bodies L1, L1′ is less susceptible to the longitudinal stresses which occur in the insulating part due to the pair of first filamentary bodies L1, L1′ entangling with each other. There is no longitudinal expansion or contraction due to the insulating parts S1, S1′ of the pair of first filamentary bodies L1, L1′ entangling with each other when the actuator 5 is driven.

Thus, even if the filamentary body L is used over a long period of time, the insulating parts S1, S1′ of the pair of first filamentary bodies L1, L1′ are unlikely to break. Because the insulating parts are unlikely to break, the risk of breakage of the conductor wires P1, P1′ of the first filamentary bodies L1, L1′ is also extremely small. If the insulating parts break, since they will no longer be able to bear the stresses acting on the wire materials and all stresses will act directly on the conductor wires, it is only a matter of time until the conductor wires break after the insulating parts break.

Furthermore, since the pair of second filamentary bodies L2, L2′ has a small diameter, it is not subjected to as great a stress as the first filamentary bodies L1, L1′ when the robot 1 is driven, and the insulating parts S2, S2′ of the pair of second filamentary bodies L2, L2′ do not break easily, and the conductor wires P2, P2′ do not break. Thus, in the first embodiment, the life of the filamentary body L including the pair of first filamentary bodies L1, L1′ and the pair of second filamentary bodies L2, L2′ can be extended. Even if the insulating parts do not break, the conductor wire itself will gradually become disconnected due to torsional fatigue caused by repeated torsional motion, but a life sufficient to complete the useful life of the robot can be ensured.

FIG. 4 is an enlarged view of a portion of a filamentary body of a second embodiment. In FIG. 4, the filamentary body L comprises a pair of first filamentary bodies L1, L1′ and a pair of second filamentary bodies L2, L2′. The pair of first filamentary bodies L1, L1′ and the pair of second filamentary bodies L2, L2′ have the same cross-sectional areas m1, m2 as described above and the same conductor cross-sectional areas of the conductor wires as described above, respectively. Furthermore, both the pair of first filamentary bodies L1, L1′ and the pair of second filamentary bodies L2, L2′ are twisted pairs of wires.

The twist of the pair of first filamentary bodies L1, L1′ is looser than the twist of the pair of second filamentary bodies L2, L2′. In the radial cross-sectional view shown on the right side of FIG. 4, circles circumscribed on the pair of first filamentary bodies L1, L1′ and the pair of second filamentary bodies L2, L2′ are indicated by dashed lines. These circumscribed circles correspond to the outer diameters of the pair of filamentary bodies as a twisted pair of wires, and specifically, the twisted outer diameter.

As shown on the right side of FIG. 4, the twisted outer diameter of the pair of first filamentary bodies L1, L1′ is D1, and the twisted outer diameter of the pair of second filamentary bodies L2, L2′ is D2. Furthermore, the twist pitch of the pair of first filamentary bodies L1, L1′ is G1, and the twist pitch of the pair of second filamentary bodies L2, L2′ is G2. Note that “twist pitch” in the present disclosure corresponds to the axial length of the twisted pair of wires required for one of the pair of filamentary body portions constituting the twisted pair of wires to change the phase over 180° in the radial cross section of the twisted pair of wires.

In the second embodiment, the ratio R1 (=G1/D1) of the twist pitch G1 of the pair of first filamentary bodies L1, L1′ to the twisted outer diameter D1 of the pair of first filamentary bodies L1, L1′ is greater than the ratio R2 (=G2/D2) of the twist pitch G2 of the pair of second filamentary bodies L2, L2′ to the twisted outer diameter D2 of the pair of second filamentary bodies L2, L2′. In other words, the pair of first filamentary bodies L1, L1′ of the second embodiment is twisted more loosely than the pair of second filamentary bodies L2, L2′.

In one example, the twisted outer diameter D1 is 4.4 mm, the twisted outer diameter D2 is 2.2 mm, the twist pitch G1 is 50 mm, and the twist pitch G2 is 10 mm. Thus, the ratio R1 is approximately 11.4, which is greater than the ratio R2, which is approximately 4.5.

Because the twist of the pair of first filamentary bodies L1, L1′ is relatively loose, the insulating parts of the pair of first filamentary bodies L1, L1′ are unlikely to be subjected to stress sufficient to cause early breakage of the insulating parts, even when the movable member 22 of the actuator 5 rotates in a direction that tightens the twist of L1, L1′ relative to the fixed member 21. Thus, as described above, the insulating parts S1, S1′ of the pair of first filamentary bodies L1, L1′ are unlikely to break, and therefore, the conductor wires P1, P1′ of the first filamentary bodies L1, L1′ are unlikely to break early. Furthermore, since the pair of second filamentary bodies L2, L2′ has a small diameter, no large stresses are applied when the robot 1 is driven, and the insulating parts S2, S2′ of the pair of second filamentary bodies L2, L2′ do not break, and as a result, the conductor wires P2, P2′ do not break. Thus, in the second embodiment, the life of the filamentary body L including the pair of first filamentary bodies L1, L1′ and the pair of second filamentary bodies L2, L2′ can be extended.

In the second embodiment, since the pair of first filamentary bodies L1, L1′ is a twisted pair of wires, the laying process of the pair of first filamentary bodies L1, L1′ can be performed more easily and in a shorter time than the laying process of the pair of first filamentary bodies L1, L1′ as two single wires in the first embodiment.

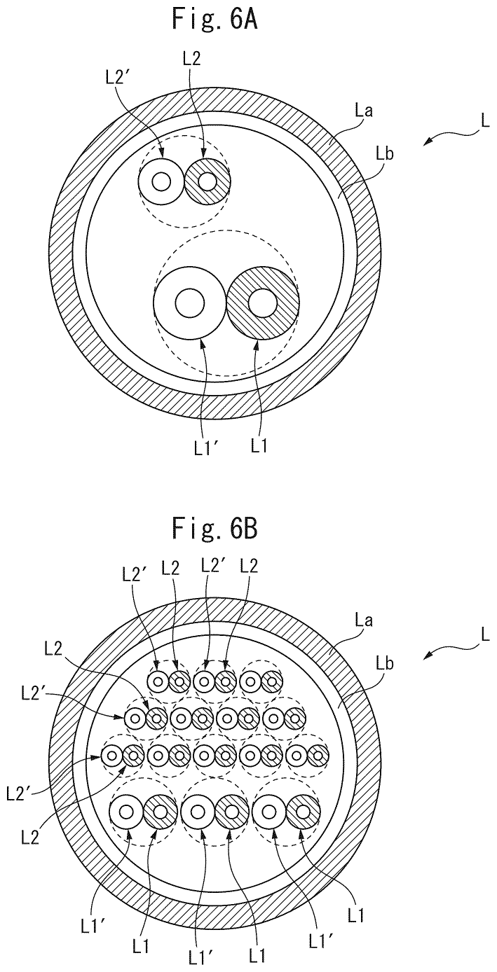

FIG. 6A is a radial cross-sectional view of a filamentary body of an example. As shown in FIG. 6A, the pair of first filamentary bodies L1, L1′ and the pair of second filamentary bodies L2, L2′ are surrounded by a braided shield Lb constituted by conductors, and the braided shield Lb is further surrounded by a covering La constituted by an insulator. In other words, the filamentary body L is an example of a composite cable that may include the covering La and the braided shield Lb.

FIG. 6B is a radial cross-sectional view of a filamentary body of another example. In FIG. 6B, the filamentary body L comprises the covering La and a braided shield Lb similar to those described above, and is an example of a composite cable in which a plurality of pairs of first filamentary bodies L1, L1′ and a plurality of pairs of second filamentary bodies L2, L2′ are arranged in the braided shield Lb. It will be understood that the filamentary body L shown in FIGS. 6A and 6B is included in the scope of the present disclosure and has the same effects as those described above.

In the prior art, a filamentary body including at least one power line and at least one signal line passes through an actuator of a robot. In order to change the specifications of an AC power source for driving a robot, such as AC 100V or AC 200V, to a DC power source, such as DC 48V, a current significantly larger than that before the specification change flows in the power line as a direct current. Thus, it becomes necessary to make the diameter of the conductor wire of the power line larger than that before the specification change. In general, the bending resistance of electric wires tends to decrease as the diameter increases. Therefore, when the reliability of twisted pairs of wires was evaluated, it was found that the insulating part of thick twisted pairs of wires tends to break early, and the conductor wire tends to break completely in a short time after that.

However, in the present disclosure, as a countermeasure against the problem described above, each of the pair of first filamentary bodies L1, L1′ is a single wire, or the pair of first filamentary bodies L1, L1′ is twisted looser than the pair of second filamentary bodies L2, L2′. Thus, in the present disclosure, even if the current flowing through the first filamentary bodies L1, L1′ as power lines is significantly large, the insulating parts S1, S1′ of the first filamentary bodies L1, L1′ will not break in a short time, and therefore, the conductor wires P1, P1′ of the first filamentary bodies L1, L1′ will not break early. The pair of second filamentary bodies L2, L2′ is also as described above.

Typically, the conductor wires P1, P1′ of the pair of first filamentary bodies L1, L1′ and/or the conductor wires P2, P2′ of the pair of second filamentary bodies L2, L2′ are composed of soft copper wires. Furthermore, these conductor wires P1, P1′, P2, P2′ may be composed of a conductor wire material having excellent fatigue strength, such as a copper alloy. In this case, bending resistance can be improved as compared to the case of a conductor wire composed of soft copper wire.

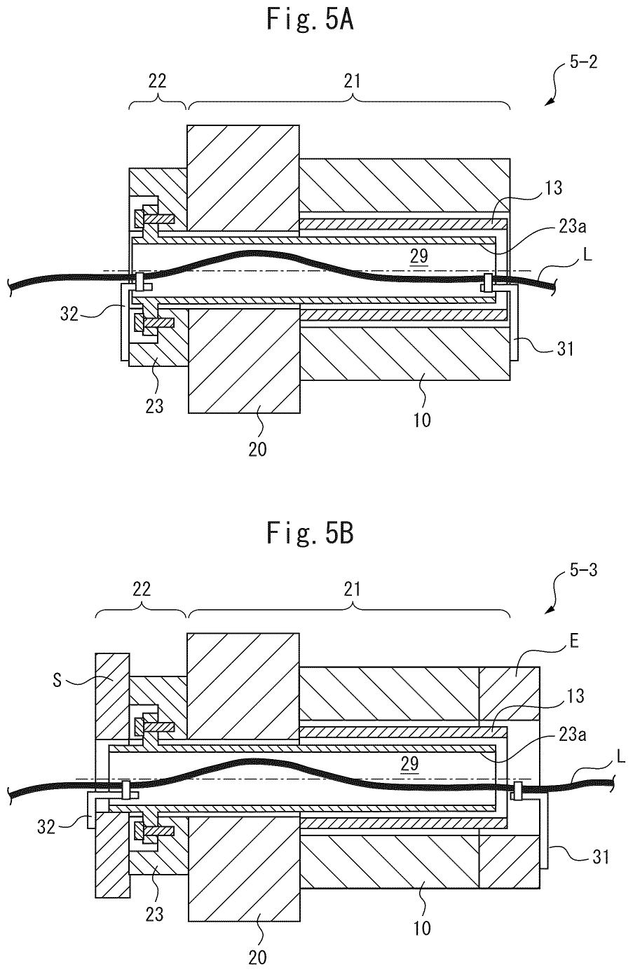

FIG. 5A is an axial cross-sectional view of an actuator based on a first modification example. The actuator 5-2 shown in FIG. 5A does not comprise a sensor S. Specifically, the movable member 22 of the actuator 5-2 comprises only the output part 23. The second affixation part 32 is affixed to the end face of the extension part 23a, and specifically, the end of the hollow hole 29. The fixed member 21 comprises the speed reducer 20 and the motor 10.

Furthermore, FIG. 5B is an axial cross-sectional view of an actuator based on a second modification example. The actuator 5-3 shown in FIG. 5B comprises an encoder E on the rear end side of the motor 10. The encoder E detects the number of rotations of the motor shaft 13 and the number of rotations of the extension part 23a by a known method. Thus, the fixed member 21 comprises the speed reducer 20, the motor 10, and the encoder E. Therefore, in FIG. 5B, the first affixation part 31 is attached to the rear end of the encoder E. The movable member 22 comprises the output part 23 and the sensor S. Though not illustrated, a driver having a hollow structure may be further mounted on the right side (rear end side) of the encoder E.

In this manner, the fixed member 21 and the movable member 22 of the actuator are not limited to the configuration shown in FIG. 2, and the scope of the present disclosure also includes cases in which the fixed member 21 comprises the encoder E and cases in which the movable member 22 does not comprise the sensor S.

Note that the filamentary body L may comprise the pair of first filamentary bodies L1, L1′, the pair of second filamentary bodies L2, L2′, and a pair of third filamentary bodies L3, L3′ (not illustrated). The thickness of the third filamentary bodies L3, L3 is between the thicknesses of the first filamentary bodies L1, L1′ and the second filamentary bodies L2, L2′.

The pair of third filamentary bodies L3, L3 may be a twisted pair of wires, or may be composed of a plurality of single wires. Furthermore, the pair of third filamentary bodies L3, L3 may have a loose twist pitch, or may have a normal twist pitch. Even such a case is included in the scope of the present disclosure.

As an effect of at least one of the embodiments described above, an actuator which ensures a long life of the filamentary body L can be provided.

It should be noted that the term “actuator” as used herein refers to a drive mechanism stored in a robot arm, etc. The actuator may be integrated with a housing member such as a robot arm, or the actuator itself may be a unit that can be separated from the housing member such as a robot arm.

Though the embodiments of the present disclosure have been described in detail, the present disclosure is not limited to the individual embodiments described above. Various additions, substitutions, modifications, and portion-wise deletions are possible in these embodiments, within the scope of the spirit of the invention, or within the scope of the idea and intent of the present invention derived from the contents described in the claims and their equivalents. For example, in the embodiments described above, the order of each operation and the order of each process are shown as examples, and are not limited to these. The same applies when numerical values or formulas are used in the description of the embodiments described above. Furthermore, appropriate combinations of some of the embodiments described above are included in the scope of the present disclosure.

In relation to the embodiments and modification examples described above, the following Addenda are further disclosed.

### Addendum 1

An actuator, comprising:
a fixed member,
a movable member which rotates relative to the fixed member,
a hollow hole which penetrates the actuator,
a filamentary body which passes through an interior of the hollow hole,
a first affixation part for affixing one portion of the filamentary body, and
a second affixation part for affixing another portion of the filamentary body, wherein
the filamentary body includes at least a pair of first filamentary bodies having a first diameter and a pair of second filamentary bodies having a second diameter which is smaller than the first diameter,
each of the pair of first filamentary bodies is a single wire, and
the pair of second filamentary bodies is a twisted pair of wires.

### Addendum 2

An actuator, comprising:
a fixed member,
a movable member which rotates relative to the fixed member,
a hollow hole which penetrates the actuator,
a filamentary body which passes through an interior of the hollow hole,
a first affixation part for affixing one portion of the filamentary body, and
a second affixation part for affixing another portion of the filamentary body, wherein
the filamentary body includes at least a pair of first filamentary bodies having a first diameter and a pair of second filamentary bodies having a second diameter which is smaller than the first diameter,
the pair of first filamentary bodies is a twisted pair of wires,
the pair of second filamentary bodies is a twisted pair of wires, and
a ratio of a twist pitch of the pair of first filamentary bodies to a twisted outer diameter of the pair of first filamentary bodies is set so as to be greater than a ratio of a twist pitch of the pair of second filamentary bodies to a twisted outer diameter of the pair of second filamentary bodies.

### Addendum 3

The actuator according to Addendum 1 or 2, wherein the pair of first filamentary bodies are power lines for supplying current.

### Addendum 4

The actuator according to Addendum 3, wherein direct current flows through the power lines.

### Addendum 5

The actuator according to any one of Addenda 1 to 4, wherein the filamentary body further comprises a braided shield which surrounds the pair of first filamentary bodies and the pair of second filamentary bodies, and a covering which surrounds the braided shield and is composed of an insulator.

### Addendum 6

The actuator according to any one of Addenda 1 to 5, wherein conductor wires of the pair of first filamentary bodies and conductor wires of the pair of second filamentary bodies are made of a copper alloy.

### Addendum 7

A robot, comprising the actuator according to any one of Addenda 1 to 6.

### DESCRIPTION OF REFERENCE SIGNS

1 robot
5, 5-2 to 5-3 actuator
10 motor
13 motor shaft
20 speed reducer
21 fixed member
22 movable member
23 output part
23a extension part
29 hollow hole
31 first affixation part
32 second affixation part
E encoder
L filamentary body
L1, L1′ pair of first filamentary bodies
L2, L2′ pair of second filamentary bodies
P1, P1′, P2, P2′ conductor wire
S force sensor
S1, S1′, S2, S2′ insulating part

1. An actuator, comprising:
a fixed member,
a movable member which rotates relative to the fixed member,
a hollow hole which penetrates the actuator,
a filamentary body which passes through an interior of the hollow hole,
a first affixation part for affixing one portion of the filamentary body, and
a second affixation part for affixing another portion of the filamentary body, wherein
the filamentary body includes at least a pair of first filamentary bodies having a first diameter and a pair of second filamentary bodies having a second diameter which is smaller than the first diameter,
each of the pair of first filamentary bodies is a single wire, and
the pair of second filamentary bodies is a twisted pair of wires.

2. An actuator, comprising:
a fixed member,
a movable member which rotates relative to the fixed member,
a hollow hole which penetrates the actuator,
a filamentary body which passes through an interior of the hollow hole,
a first affixation part for affixing one portion of the filamentary body, and
a second affixation part for affixing another portion of the filamentary body, wherein
the filamentary body includes at least a pair of first filamentary bodies having a first diameter and a pair of second filamentary bodies having a second diameter which is smaller than the first diameter,
the pair of first filamentary bodies is a twisted pair of wires,
the pair of second filamentary bodies is a twisted pair of wires, and
a ratio of a twist pitch of the pair of first filamentary bodies to a twisted outer diameter of the pair of first filamentary bodies is set so as to be greater than a ratio of a twist pitch of the pair of second filamentary bodies to a twisted outer diameter of the pair of second filamentary bodies.

3. The actuator according to claim 1, wherein the pair of first filamentary bodies are power lines for supplying current.

4. The actuator according to claim 3, wherein direct current flows through the power lines.

5. The actuator according to claim 1, wherein the filamentary body further comprises a braided shield which surrounds the pair of first filamentary bodies and the pair of second filamentary bodies, and a covering which surrounds the braided shield and is composed of an insulator.

6. The actuator according to claim 1, wherein conductor wires of the pair of first filamentary bodies and conductor wires of the pair of second filamentary bodies are made of a copper alloy.

7. A robot, comprising the actuator according to claim 1.

8. The actuator according to claim 2, wherein the pair of first filamentary bodies are power lines for supplying current.

9. The actuator according to claim 8, wherein direct current flows through the power lines.

10. The actuator according to claim 2, wherein the filamentary body further comprises a braided shield which surrounds the pair of first filamentary bodies and the pair of second filamentary bodies, and a covering which surrounds the braided shield and is composed of an insulator.

11. The actuator according to claim 2, wherein conductor wires of the pair of first filamentary bodies and conductor wires of the pair of second filamentary bodies are made of a copper alloy.

12. A robot, comprising the actuator according to claim 2.
